(19) United States
(12) Patent Application Publication
(10) Pub. No.: US 2009/0274879 A1
(43) Pub. Date: Nov. 5, 2009

(54) Decorative plastic card

(76) Inventors: SURESH C. PRIYA, Aurora, IL (US); SAJIT PAUL, Plainfield, IL (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/383,250

(22) Filed: Mar. 20, 2009

Related U.S. Application Data
(60) Provisional application No. 61/070,338, filed on Mar. 21, 2008.

(51) Int. Cl. B32B 3/10; B32B 37/02

(52) U.S. Cl. 428/172; 428/201; 428/203; 156/250

(57) ABSTRACT

A decorative plastic card is provided. The decorative plastic card may have a first overlay, a second overlay, and a decorative PVC layer sandwiched between the first and second overlays. The decorative layer preferably has a decorative pattern that extends from a first outer surface of the decorative layer, through the decorative layer to a second opposing outer surface of the decorative layer. The first overlay, the decorative layer and the second overlay are laminated together to form the plastic card. Additionally, the decorative plastic card may also have a first substrate positioned between the first overlay and the decorative layer, and a second substrate positioned between the decorative layer and the second overlay.

### CROSS-REFERENCE TO RELATED APPLICATIONS

This application is a continuation-in-part of U.S. Provisional Patent Application Ser. No. 61/070,338, filed on Mar. 21, 2008, which is expressly incorporated herein by reference.

### FEDERALLY SPONSORED RESEARCH OR DEVELOPMENT

Not Applicable.

### TECHNICAL FIELD

The present invention relates generally to a plastic card, and more specifically to a plastic card incorporating a decorative PVC layer.

### BACKGROUND OF THE INVENTION

Various types of laminated plastic cards, such as credit cards and gift cards, are well known in the art. Recently, efforts have been made to provide these cards with attractive, distinctive appearances to identify and promote the company or entity issuing the card. Generally, such cards are made by applying a clear vinyl film, such as a polyvinyl chloride (PVC), over the printing on a white vinyl core, also of PVC, and laminating the materials together under heat and pressure in a hydraulic laminating press to protect the surface of the card including the printing thereon. In addition to mere printing for the distinctive appearance, it has been desirable to provide attractive decorative materials as an internal component of the card. Traditionally, however, such materials, such as a metalized layer identified in U.S. Pat. No. 4,897,533, commonly assigned to the Assignee herein, require a polyester film as a carrier. Additionally, such materials are limited in their decorative appearance, and for example have not provided an appearance of a three-dimensional surface. While such decorative materials according to the prior art provide a number of advantages over prior plastic cards, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a decorative plastic card. According to one embodiment the decorative plastic card comprises a first overlay, a second overlay, and a decorative PVC layer sandwiched between the first and second overlays. In a preferred embodiment, the first overlay, the decorative layer and the second overlay are laminated together to form the plastic card. Additionally, no polyester film carrier is required.

According to another embodiment, the PVC decorative layer has a decorative pattern that extends from a first outer surface of the decorative layer, through the decorative layer to a second opposing outer surface of the decorative layer. In another embodiment, the decorative pattern is a three-dimensional decorative pattern or appearance. In yet another embodiment, the three-dimensional decorative pattern is a non-printed pattern.

According to another embodiment, the decorative plastic card further comprises a first substrate positioned between the first overlay and the decorative layer, and a second substrate positioned between the decorative layer and the second overlay. In one embodiment, the first substrate is substantially clear, and the second substrate is opaque.

According to another embodiment, the decorative plastic card further comprises a contactless electronic element positioned between the first substrate and the second substrate.

According to another embodiment, the decorative plastic card comprises a first overlay, a first substrate, a PVC decorative layer having a non-printed three-dimensional appearance visible through a surface thereof, a second substrate and a second overlay. In one embodiment, the first overlay, the first substrate, the decorative layer, the second substrate and the second overlay are laminated together to form a plastic card. In a preferred embodiment, the non-printed three-dimensional appearance of the decorative layer extends from a first outer surface of the decorative layer, through the decorative layer to a second opposing outer surface of the decorative layer.

According to another embodiment, the plastic card is provided in a CR80 size.

According to another embodiment, the decorative plastic card comprises a first overlay, a second overlay, and a PVC decorative layer sandwiched between the first and second overlays. The PVC decorative layer has a decorative pattern that extends from a first outer surface of the decorative layer, through the decorative layer to a second opposing outer surface of the decorative layer, and the decorative pattern is visible through the first and second overlays. In another embodiment, the decorative plastic card further comprises a substrate layer between the decorative layer and the second overlay, and a contactless electronic element positioned between the decorative layer and the substrate layer.

According to another embodiment, a method of creating a decorative plastic card is provided. In one embodiment the method comprises the steps of: providing a first overlay; providing a decorative PVC layer having a non-printed three-dimensional appearance visible through a surface thereof, the decorative pattern extending from a first outer surface of the decorative layer, through the decorative layer to a second opposing outer surface of the decorative layer; providing a second overlay; laminating the first overlay, the decorative layer and the second overlay together with heat and pressure; and, cutting the laminated first overlay, decorative layer and second overlay in substantially a CR80 size to form a plastic card.

According to yet another embodiment, the method creating a decorative plastic card also comprises the steps of providing a substrate layer between the decorative layer and the second overlay, providing a contactless electronic element between the substrate layer and the second overlay, and laminating the first overlay, decorative layer, contactless electronic element, substrate layer and second overlay together with heat and pressure.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a front view of one embodiment of a decorative card with a three-dimensional decorative layer;

FIG. 2 is an exploded side cross-sectional view of the card through line 2-2 of FIG. 1;

FIG. 3 is a front view of another embodiment of a decorative card with a three-dimensional decorative insert;

FIG. 4 is a front view of another embodiment of a decorative card with a three-dimensional decorative insert;

FIG. 5 is a back view of one embodiment of a decorative card having a three-dimensional decorative insert;

FIG. 6 is an exploded side cross-sectional view of the card through line 6-6 of FIG. 7;

FIG. 7 is a front view of another embodiment of a decorative card with a decorative insert;

FIG. 8 is a back view of the decorative card of FIG. 7;

FIG. 9 is a front view of another embodiment of a decorative card with a decorative insert;

FIG. 10 is a back view of the decorative card of FIG. 9;

FIG. 11 is a front view of another embodiment of a decorative card with a decorative insert; and,

FIG. 12 is an exploded side cross-sectional view of a decorative card having an electronic element.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

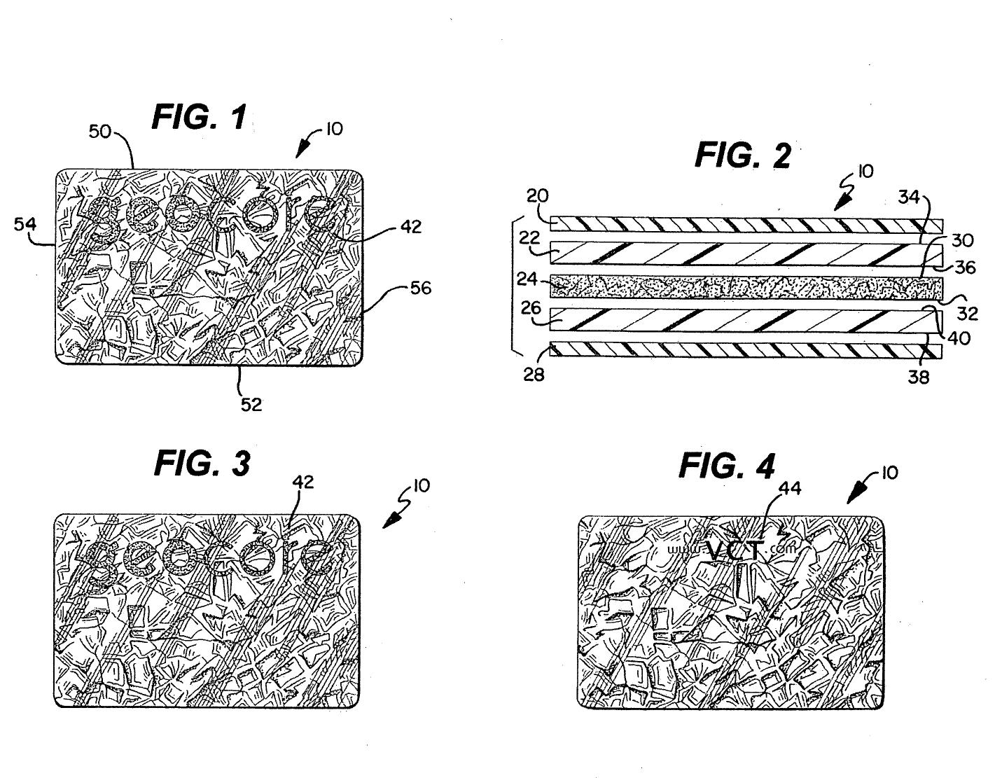

Referring now to the Figures, and specifically FIG. 1, there is shown a decorative card 10. Generally, the decorative card 10 is a laminated plastic card, and one embodiment preferably has a three-dimensional decorative flexible polyvinyl chloride (PVC) layer therein. The decorative card 10 may be used as a secure and non-secure banking card, financial card, smart card, contactless card, gift card, ATM card, debit card, retail store issued card, phone card, ID card, promotional card, key card, etc.

In a preferred embodiment, the decorative card 10 has a size which meets CR80 specifications (i.e., nominal size of approximately 3.375″×2.125″). As such, the decorative card 10 can be manufactured utilizing many standard processes and standard machinery. Further, such size provisions are required for the card 10 to be used as a financial card. Additionally, the decorative card 10 is preferably substantially planar (i.e., generally flat) and rigid (i.e., able to maintain its form and shape, but can still be flexed to a degree and return to its original shape). Such a definition for rigid is juxtaposed from a material that when flexed does not return to its original shape and form. These meanings of planar and rigid are utilized throughout. Additionally, it is understood that the card 10 may be rigid even though one or more components that comprised the card 10 are flexible.

Referring to FIG. 2, the decorative card 10 comprises a plurality of different layers. In one embodiment, the various layers embodied in the decorative card 10 comprise a top overlay 20, a first substrate 22, a decorative layer 24, a second substrate 26 and a bottom overlay 28. It is understood that card 10 may comprise a fewer or greater number of layers than identified above. Accordingly, as shown in FIG. 6, in another embodiment the decorative card 10 comprises only three layers, including a top overlay 20, a decorative layer 24, and a bottom overlay 28. In such an embodiment the top surface 30 and the bottom surface 32 of the decorative layer 24 will be visible through the clear overlays 20, 28. Alternate embodiments with different layers are also described herein.

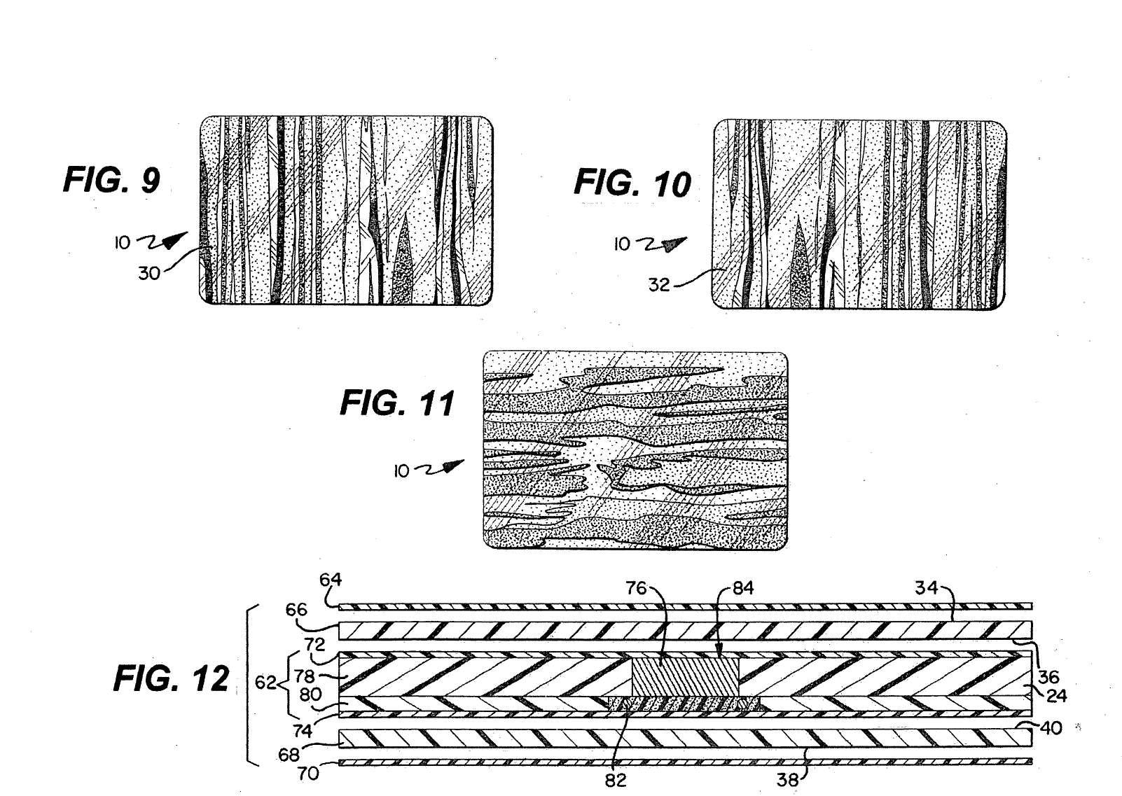

The decorative layer 24 preferably comprises a flexible PVC layer. In addition to polyvinyl chloride, the decorative layer 24 may also include dioctyl phthalate, various additives, and pigments to alter the color of the decorative layer 24. Further, in a preferred embodiment the decorative layer 24 does not require a polyester (PET) film carrier. In one embodiment the decorative layer 24 has the appearance of a three-dimensional surface on one surface thereof. In a further embodiment, the decorative layer 24 has a three-dimensional appearance on the first surface 30 and the second surface 32 thereof. In a preferred embodiment the three-dimensional appearance or pattern extends through the sheet from the first surface 30 to the second surface 32 thereof. One embodiment of a decorative card 10 having a decorative layer 24 with a pattern that extends through the entire decorative layer 24 from the first surface 30 to the second surface 32 is shown in FIGS. 7 and 8. The top surface of the decorative card 10 is shown in FIG. 7, while the bottom surface of the decorative card 10 is shown in FIG. 8. Because these cards 10 have a clear first and second substrates 22, 26, the pattern on the first surface 30 of the decorative layer 24 is visible at the front or top side of the decorative card 10, and the pattern on the second surface 32 of the decorative layer 24 is visible at the back or bottom side of the decorative card 10. FIGS. 9 and 10 provide another embodiment wherein the surfaces 20, 32 of the decorative layer 24 are visible at their respective front or top side of the decorative card 10, as well as the back or bottom side of the decorative card 10. This embodiment illustrates another embodiment wherein the pattern of the decorative layer 24 extends from the first surface 30 through the layer to the second surface 32. FIG. 11 illustrates yet another pattern of a decorative layer 24 for a decorative card 10. The number of different decorative patterns available is virtually unlimited.

The surface of the decorative layer 24 may have a gloss, matte or textured surface finish. In one embodiment the three-dimensional appearance of the decorative layer 24 is that of granite, however, other three-dimensional patterns are available. One such material that can be utilized as the decorative layer 24 having a three-dimensional pattern is available from Delmar Products, Inc., and identified as Sicobloc. In one embodiment the decorative layer 24 is approximately 8 mils. thick, however, it is understood that the decorative layer 24 may be thicker or thinner. Additionally, the decorative layer 24 is preferably provided in a sheet or roll form. While printing may be applied to the decorative layer 24, as explained herein it is preferred that any printing be applied to either the first and/or second substrates 22, 26. Additionally, in preferred embodiments the decorative pattern is not provided by a printing process. Thus, the decorative pattern extends through the decorative layer 24, as opposed to being merely on a surface of the decorative layer 24.

The first and second substrates 22, 26 are generally made of a generally rigid and substantially planar plastic material. In a preferred embodiment, the first and second substrates 22, 26 are made of a 3 to 10 mil. clear or colored core PVC material, however, it is understood that thinner or thicker substrates, as well as different materials, may be utilized. The material may be provided in sheet or roll form. Referring to FIG. 2, the first substrate 22 has an outer or first surface 34 and an inner or second surface 36. Similarly, the second substrate 26 has an outer or first surface 38 and an inner or second surface 40. In a most preferred embodiment, the first substrate 22 is preferably clear, and the second substrate 26 is preferably white or colored. Accordingly, by having the first substrate 22 clear the decorative layer 24 is visible through the front or top surface of the card 10. Similarly, by having the second substrate 26 white or colored the decorative layer 24 is not visible through the second or rear surface of the card 10. Alternately, both the first and second substrates 22, 26 may be clear to allow the decorative layer 24 to be visible through both the front or top surface of the card 10, as well as the rear or bottom surface of the card 10, as shown in FIGS. 7-11.

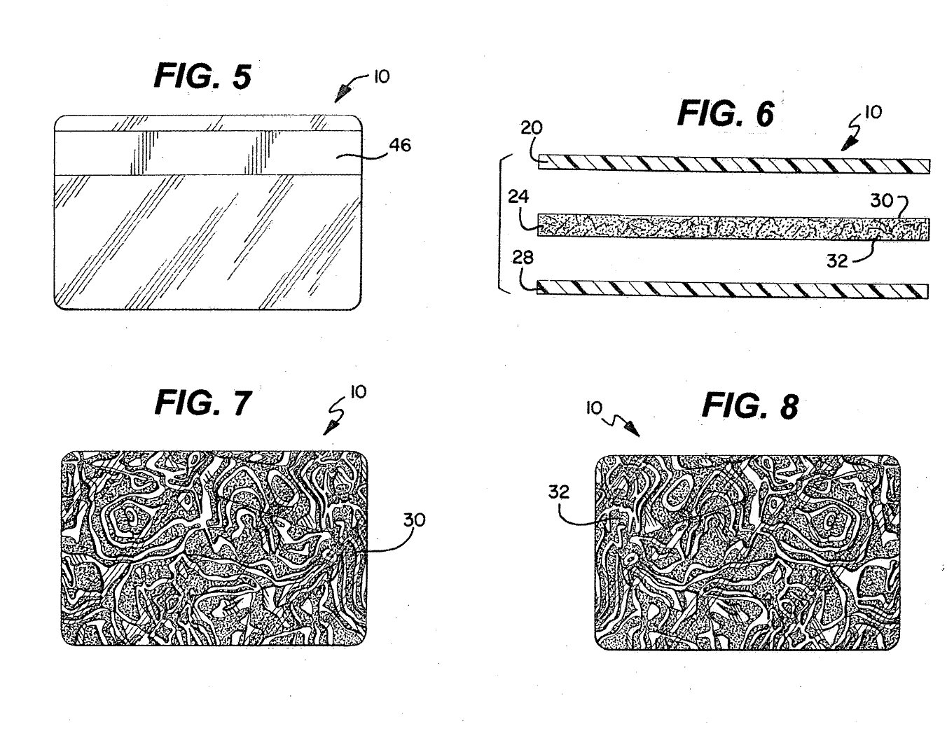

As explained above, printing may be applied to any of the components of the card 10. Preferably, however, printing is applied to the first and second substrates 22, 26. Most preferably, the outer surfaces of the first and second substrates 22, 26 (i.e., the first surface 34 of the first substrate 22, and the first surface 38 of the second substrate 26) may have printing thereon. For example, FIGS. 1 and 3 employ printing 42 on one of the surfaces of the first substrate 22. Alternatively, FIG. 4 illustrates printing 44 on the outer surface of the top overlay 20. The printing may be accomplished through a variety of printing processes. Various processes which may be utilized are litho printing, including using an offset litho process and/or a silkscreen process. Additionally, a flexographic process may be utilized. Further, foil stamped printing process may be utilized, as shown in FIG. 4. It is understood that additional printing processes may also be utilized. Further, a contact machine readable member, such as a magnetic strip or bar code strip, may be provided to the appropriate layer of the card 10. FIG. 5 illustrates a magnetic strip 46 that is generally applied to outer surface of the bottom overlay 28, but which may be applied to other layers. Alternately, as described herein, a contactless electronic element may be utilized in the card 10.

Additionally, in a preferred embodiment the top and bottom overlays 20, 28, also referred to as over-laminating film in certain processes, are generally made of a plastic material, typically a clear or transparent plastic material, and preferably are made of clear PVC. In a preferred embodiment, the overlays 20, 28 are approximately 2 mil. thick, however, it is understood that thinner or thicker overlays, as well as different materials, may be utilized without departing from the scope of the present invention. For example, the thickness of the film for the overlays 20, 28 may be within the range of from 1 mil. to about 6 mil. The overlay material preferably has properties of being heat-sealable, durable, low permeability to oxygen, carbon dioxide and gases in general, and is a material that has strength and flexibility at both room temperature and low temperatures. The overlay material may be provided in sheet or roll form. Alternatively, the overlay may be provided in a printing or silk screen process, or any equivalent process.

The decorative card 10 also has a plurality of sides or edges. In one embodiment wherein the decorative card 10 is generally rectangular, such as when it is sized to CR80 specifications, the card 10 has a first side 50, a second side 52 opposing the first side 50, a third side 54 and a fourth side 56 opposing the third side 54. The sides 50, 52, 54 and 56 of the card 10 define a perimeter or boundary of the card 10.

In a preferred embodiment, a plurality of decorative cards 10, each generally having a decorative layer 24 associated therewith, are manufactured simultaneously in a part of a common sheet and are later punched or cut from the larger common sheet. Thus, the outer perimeter of each of the layers of the decorative card 10 may be identical because each of the respective outer sides or edges of each of the layers of the decorative card 10 are manufactured simultaneously as a unit. Alternatively each card 10 may have a different size.

Typically, for the assembly step each of the layers have been pre-manufactured to their individual desired final state. For example, the first and second substrates 20, 26 may have been pre-printed with the appropriate printing, etc. After the desired layers are provided, the next step is generally a collation step to place the layers in the appropriate order. After the layers are collated the sheets are connected. In a preferred embodiment the connection step is accomplished through a lamination process in a platen press under controlled conditions. For example, in one lamination process the layers are laminated at approximately 300° F.-340° F. at a pressure of approximately 145 PSI for a period of time. Typically, the layers are then cooled for an additional period of time under pressure, often at a greater pressure than used during the laminating step. It is understood that different materials and layer combinations will require different lamination process parameters. Alternatively, a water or solvent based adhesive may be used to improve core stock bonding, if necessary.

After the layers are connected, the connected sheets are cut into individual cards, preferably in a die cutter, to the desired card size, typically that which meets CR80 specifications.

According to another embodiment, as shown in FIG. 12, the decorative card 10 also has an electronic element 60, preferably provided as part of an inlay 62. In one such embodiment the decorative card 10 comprises a plurality of different layers. In one embodiment, the various layers embodied in the decorative card 10 with the electronic element 60 comprise a top overlay 64, a first substrate 66, an inlay 62, a second substrate 68 and a second or bottom overlay 70. The inlay 62 contains the decorative layer 24. As always, it is understood that card 10 may comprise a fewer or greater number of layers than identified above.

As shown in FIG. 12, in one embodiment, the inlay layer 62 comprises a first outer inlay layer 72, a second outer inlay layer 74, an electronic element 76, a first inlay substrate 78, and a second inlay substrate 80. Each of these layers is generally connected. It is understood that the inlay layer 62 may comprise a fewer or greater number of layers than identified above. For example, the inlay layer 62 may comprise an electronic element 76 on or embedded into one of the inlay substrates 78, 80. A description of a card with an electronic element is described in commonly assigned U.S. application Ser. No. 11/344,578, published as US2007/0176007A1, which is hereby incorporated herein by reference and made a part hereof. In a preferred embodiment the first inlay substrate 78 is the decorative layer 24.

The electronic element 76 may perform a wide variety of functions, and take a wide variety of forms. In one embodiment, the electronic element 76 is a chip 76, such as a micro chip. One type of chip is a radio frequency or RF chip. Further, in various embodiments an antenna 82, such as at least one wire coil 82 or a circuit board is associated with the chip. In the embodiment illustrated, a plurality of windings of coil wire 82 operate as the antenna 82 for the chip 76. In such an embodiment, the ends or some other area of the wire coil 82 contact the chip 76. The term transponder is utilized herein to define a chip 76 having an antenna 82.

In the preferred embodiment of the inlay layer 62, as shown in FIG. 12, the inlay layer 62 is generally made in accordance with the following process. First, the coil windings of the antenna 82 are connected to the second inlay substrate 80, and preferably, the coil windings 82 are at least partially embedded into the second inlay substrate 80. In a preferred embodiment the second inlay substrate 80 is approximately 85 microns thick, and is typically made of a plastic material, the preferred being polyvinyl chloride (PVC). Further, the coil windings 82 are preferably made of copper wire. The coil windings 82 may have a varied number and shape. Generally, the overall length of the windings, the size of the wire and the type of wire will affect the resonance frequency of the transponder. Different size windings are provided for different applications.

The chip 76 is electrically connected to the coil windings 82. An epoxy or other suitable material may be utilized to secure the coil windings 82 to the chip 76. In one embodiment the preferred chip 76 is a Mifare chip, such as a Mifare 1 K/MOA4 chip (although alternate chips may be utilized) having a thickness of approximately 210 microns. Because the chip 76 has a thickness, in order to maintain a generally even thickness to the overall inlay 62, a first inlay substrate 78 having approximately the same thickness as the chip 76, but having an aperture 84 sized to accommodate the chip 76, is utilized. In a preferred embodiment of the decorative card 10, the first inlay substrate 78 is the decorative layer 24. By utilizing a first inlay substrate 78 having approximately the same thickness of the chip 76, when the first inlay substrate 78 is placed on the second inlay substrate 80, the chip 76 is located in the aperture 84 and the overall thickness of the inlay layer 62 is substantially flat. Finally, the first outer inlay layer 72 is positioned on the outer surface of the first inlay substrate 78, and the second outer or bottom inlay layer 74 is positioned on the outer surface of the second inlay substrate 80. In one embodiment, the first outer inlay layer 72 is approximately 100 microns thick, the second outer inlay layer 74 is approximately 85 microns thick, and the second inlay substrate 80 is approximately 85 microns thick. Each of the layers of the inlay 62 are laminated together with an appropriate amount of heat and pressure to form the single inlay layer 62. Thus, with all of the layers laminated together the complete inlay layer 62 has an overall thickness of approximately 480 microns. Additionally, with the top overlay 64 (approximately 2 mil. or 50.8 microns thick), first substrate 66 (approximately 5 mil. or 127 microns thick), the second substrate 68 (approximately 5 mil. or 127 microns thick), and the bottom overlay 70 (approximately 2 mil. or 50.8 microns thick), the total thickness of the card 10 is approximately 835 microns.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A decorative plastic card, comprising:
a first overlay, a second overlay, and a PVC decorative layer sandwiched between the first and second overlays, wherein the PVC decorative layer has a decorative pattern that extends from a first outer surface of the decorative layer, through the decorative layer to a second opposing outer surface of the decorative layer.

2. The decorative plastic card of claim 1, wherein the first overlay, decorative layer and second overlay are laminated together to form a plastic card.

3. The decorative plastic card of claim 2, wherein the first substrate is substantially clear, and wherein the second substrate is opaque.

4. The decorative plastic card of claim 1, further comprising a first substrate positioned between the first overlay and the decorative layer, and a second substrate positioned between the decorative layer and the second overlay.

5. The decorative plastic card of claim 4, further comprising a contactless electronic element positioned between the first substrate and the second substrate.

6. The decorative plastic card of claim 1, wherein the decorative pattern is a three-dimensional appearance.

7. The decorative plastic card of claim 5, wherein the three-dimensional decorative pattern is a non-printed pattern.

8. A decorative plastic card, comprising:
a first overlay;
a first substrate;
a PVC decorative layer having a non-printed three-dimensional appearance visible through a surface thereof;
a second substrate; and,
a second overlay, wherein the first overlay, first substrate, decorative layer, second substrate and second overlay are laminated together to form a plastic card.

9. The decorative plastic card of claim 8, wherein the first substrate is substantially clear, and wherein the second substrate is opaque.

10. The decorative plastic card of claim 9, further comprising a machine readable member connected to the card.

11. The decorative plastic card of claim 10, wherein the machine readable member is a magnetic strip.

12. The decorative plastic card of claim 8, wherein the non-printed three-dimensional appearance of the decorative layer extends from a first outer surface of the decorative layer, through the decorative layer to a second opposing outer surface of the decorative layer.

13. The decorative plastic card of claim 8, further comprising a transponder positioned between the first substrate and the second substrate.

14. The decorative plastic card of claim 13, wherein the transponder is at least partially within the decorative layer.

15. A decorative plastic card, comprising:
a first overlay, a second overlay, and a PVC decorative layer sandwiched between the first and second overlays, wherein the PVC decorative layer has a decorative pattern that extends from a first outer surface of the decorative layer, through the decorative layer to a second opposing outer surf ace of the decorative layer, and wherein the decorative pattern is visible through the first and second overlays.

16. The decorative plastic card of claim 15, further comprising a substrate layer between the decorative layer and the second overlay, and a contactless electronic element positioned between the decorative layer and the substrate layer.

17. A method of creating a decorative plastic card, comprising the steps of:
providing a first overlay;
providing a decorative PVC layer having a non-printed three-dimensional appearance visible through a surface thereof, the decorative pattern extending from a first outer surface of the decorative layer, through the decorative layer to a second opposing outer surface of the decorative layer;
providing a second overlay;
laminating the first overlay, decorative layer and second overlay together with heat and pressure; and,
cutting the laminated first overlay, decorative layer and second overlay in substantially a CR80 size to form a plastic card.

18. The method of claim 17, further comprising the steps of providing a substrate layer between the decorative layer and the second overlay, providing a contactless electronic element between the substrate layer and the second overlay, and laminating the first overlay, decorative layer, contactless electronic element, substrate layer and second overlay together with heat and pressure.
